(19) United States
(12) Patent Application Publication
(10) Pub. No.: US 2026/0168294 A1
(43) Pub. Date: Jun. 18, 2026

(54) MOTOR VEHICLE LOCK, IN PARTICULAR MOTOR VEHICLE DOOR LOCK

(71) Applicant: KIEKERT AKTIENGESELLSCHAFT, Heiligenhaus (DE)

(72) Inventor: Tobias STEFFEN, Essen (DE)

(73) Assignee: KIEKERT AKTIENGESELLSCHAFT, Heiligenhaus (DE)

(21) Appl. No.: 18/715,814

(22) PCT Filed: Dec. 1, 2022
(86) PCT No.: PCT/EP2022/084008

§ 371 Date: Jun. 3, 2024

(30) Foreign Application Priority Data
Dec. 15, 2021 (DE) 10 2021 133 209.5

(51) Int. Cl. E05B 81/14; E05B 77/06; E05B 77/12; E05B 77/26; E05B 81/06; E05B 81/16; E05B 81/20; E05B 85/02

(52) U.S. Cl. CPC E05B 81/14; E05B 77/06; E05B 77/12; E05B 77/26; E05B 81/06; E05B 81/16; E05B 81/20; E05B 85/02

(57) ABSTRACT

A motor vehicle lock, in particular a motor vehicle door lock, is equipped with an actuating lever chain with at least one release lever and one actuating lever. Also implemented is a securing device which, in its “secured” position, mechanically decouples the actuating lever from the release lever and, in its “unsecured” position, mechanically couples the two levers to one another. According to the invention, the securing device has a coupling slide, which is supported on the actuating lever and is predominantly linearly movable, for selectively mechanically decoupling/coupling the actuating lever from/to the release lever.

The invention relates to a motor vehicle lock, in particular a motor vehicle door lock, having an actuating lever chain with at least one release lever and one actuating lever, and having a securing device which, in its “secured” position, mechanically decouples the actuating lever from the release lever and, in its “unsecured” position, mechanically couples the two levers to one another.

In its “secured” position, the securing device therefore ensures that the actuating lever chain is interrupted, so that the actuating lever cannot be acted upon against a closed locking mechanism consisting substantially of a catch and a pawl provided at the end of the actuating lever chain. This means that even when the actuating lever chain is acted upon, the locking mechanism in question cannot be opened via the mechanically opened or disconnected actuating lever chain. If, on the other hand, the securing device assumes its “unsecured” functional position, the actuating lever chain in question is closed and the locking mechanism provided at the end can be opened. For this purpose, the release lever usually works on the pawl as a component of the locking mechanism and ensures that the pawl is lifted from its engagement with the catch. The catch then opens with the aid of a spring and releases a previously caught locking pin. The associated motor vehicle door lock and also the motor vehicle door can be opened.

In the case of a motor vehicle lock of the generic type and mentioned here by way of example according to EP 1 319 781 A2 of the applicant, the detailed procedure is such that the securing device is designed as a child safety device. For this purpose, the child safety device works on a control lever which, in its engaged position, entrains a locking lever when the actuating lever is triggered and, in its disengaged position, decouples the locking lever from movements of the actuating lever. The child safety device itself has an eccentric and a pin for this purpose and is usually manually pivotable.

For reasons of convenience, however, such securing devices and child safety devices in particular are increasingly being equipped with an electromotive drive. In practice, this often poses the problem that the associated electromotive drive must act on the entire child safety device in order to realize and implement the different positions in the sense of “secured” on the one hand and “unsecured” on the other. This in turn often leads to a relatively expansive design of the electromotive drive and also to increased costs. The invention as a whole seeks to remedy this.

The invention is based on the technical object of further developing such a motor vehicle lock and in particular a motor vehicle door lock in such a way that the effort and the manufacturing costs are reduced.

In order to achieve this technical object, a generic motor vehicle lock and in particular a motor vehicle door lock is characterized within the scope of the invention in that the securing device has a coupling slide, which is supported on the actuating lever and is predominantly linearly movable, for selectively mechanically decoupling/coupling the actuating lever from/to the release lever.

In a further advantageous embodiment, the coupling slide can be acted upon with the aid of a securing lever as a further component of the securing device. In addition, the coupling slide is also acted upon in the direction of its “engaged” position with the aid of a spring. As a result, in its “secured” position, the securing lever acts on the coupling slide against the force of the aforementioned spring into its “disengaged” position. Finally, in this context, the design is such that the securing lever is designed to be pivotable about an axis via an electromotive drive.

In the scope of the invention, the securing lever as a component of the securing device can be advantageously controlled and pivoted about its axis by means of an electromotive drive. In principle, manual action on and control of the securing lever is of course also conceivable and is encompassed by the invention. By using the electromotive drive, the securing device can easily be acted upon remotely from a dashboard, for example.

The securing device is generally a child safety device, i.e. a securing device that is typically used on the rear side doors of motor vehicles. By using the electromotive drive to act on the securing lever, the securing device or child safety device can now be easily switched on and off by a driver or passenger using a switch on the dashboard or a corresponding menu control. This makes operation easier and particularly convenient.

A further advantage of the invention is that the electromotive drive for pivoting the securing lever about its axis can be realized and implemented in a particularly simple and compact manner and therefore cost-effectively. This is because, with the aid of the electromotive drive and the securing lever, in the “secured” position of the securing device it is only necessary to act on the coupling slide against the force of the spring assigned thereto into its “disengaged” position, or to keep it in this “disengaged” position for the duration in which the “secured” position is assumed.

As soon as the electromotive drive does not (or no longer) act on the securing lever in this “disengaged” position, the spring in question ensures, with its aid, that the coupling lever is acted upon in the direction of its “engaged” position. As a result, the coupling slide can be held in its “disengaged” position easily and with little force via the electromotive drive and automatically returns, supported by the force of the spring, to its “engaged” position when the coupling slide is no longer acted upon with the aid of the securing lever.

This procedure also opens up the possibility of realizing and implementing a so-called “override” function. In other words, in this case, a single stroke of the actuating lever is sufficient to both unlock and open the motor vehicle lock. The stroke in question on the actuating lever may correspond to the fact that the securing lever is no longer acted upon by the electromotive drive, so that the coupling slide is moved into its “engaged” position by the force of the spring. In this “engaged” position, the actuating lever chain is now closed, so that in the course of this one (single) stroke of the actuating lever, the engaged coupling slide can then immediately act on the release lever, which in turn lifts the pawl from its latching engagement with the catch, as described. All of this is achieved with very little force and consequently with reduced effort and a low energy input, resulting in particular advantages.

In a further advantageous embodiment, the coupling slide is usually guided in a recess in the actuating lever. In addition, the coupling slide advantageously has a longitudinal bore through which a guide element on the actuating lever passes. The joint design of the recess on the one hand and the longitudinal bore on the other ensures that the coupling slide is not only supported by the actuating lever, but is also predominantly linearly movable relative to the actuating lever, as already described above. The recess in the actuating lever guides the coupling slide, which is then additionally supported by the guide element on the actuating lever, which passes through and engages over the longitudinal bore in the coupling slide.

The securing lever is advantageously not only coupled to the electromotive drive, but also usually has a sensor that monitors its position. The sensor can be a switch and in particular a microswitch. In addition, the design is usually such that the sensor and the electromotive drive are connected to a common control unit. With the aid of the control unit, the electromotive drive and thus the securing lever can now advantageously be acted upon. In addition, the control unit can implement and realize any operating commands with regard to the securing device in the sense of “securing device on” or “securing device off.”

In the specific example, the desired “securing device on” or “child safety lock on” functional position corresponds to the control unit acting on the electromotive drive, which in turn pivots the securing lever about its axis so that the coupling slide on the actuating lever is acted upon against the force of the spring with the aid of the pivoting securing lever so that the coupling slide assumes its “disengaged” position. Any actuation of the actuating lever therefore corresponds to an idle movement relative to the release lever and thus also to the closed locking mechanism. This locking mechanism can therefore not be opened.

If, on the other hand, the “securing device off” or “child safety lock off” functional position is to be realized and implemented, the control unit ensures that the electromotive drive does not (or no longer) pivot the securing lever. This means that the securing lever returns to its initial position or rest position, which can be verified using the sensor that monitors the position of the securing lever. As a result of this, the spring acting on the coupling slide in the direction of its “engaged” position ensures that the actuating lever chain is closed, so that a corresponding action on the actuating lever is immediately converted into a desired locking mechanism opening as described. In other words, the control unit can release the electromotive drive and thus the securing lever as required, so that when it is acted upon, the actuating lever not only pivots the secured securing lever via the coupling slide and thereby “engages” the coupling slide, but the locking mechanism can also be opened all at once by the actuating lever chain produced and closed in this way. This means that the “unlock” and “open” functional positions can be realized and implemented all at once in the sense of the “override” function described above. This is particularly convenient and can also be realized with little design effort and with reduced energy consumption for powering the electromotive drive compared to the prior art.

In addition, if the electrical energy supply to the electromotive drive fails, the securing lever usually cannot (or can no longer) hold the coupling slide in its “disengaged” position against the force of the spring assigned to the coupling slide. This means that the coupling slide (automatically) moves into the “engaged” position so that any failure of the electromotive drive can be easily controlled because the actuating lever and the engaged coupling slide can then be used to act on the locking mechanism via the actuating lever chain, which is closed as a result.

It is understood that the actuating lever chain is designed as an internal actuating lever chain in the case of implementing a child safety device. Any external actuating lever chain and its function therefore remain unaffected. These are the main advantages.

In the following, the invention is explained in more detail with the aid of a drawing showing only an exemplary embodiment; in the figures:

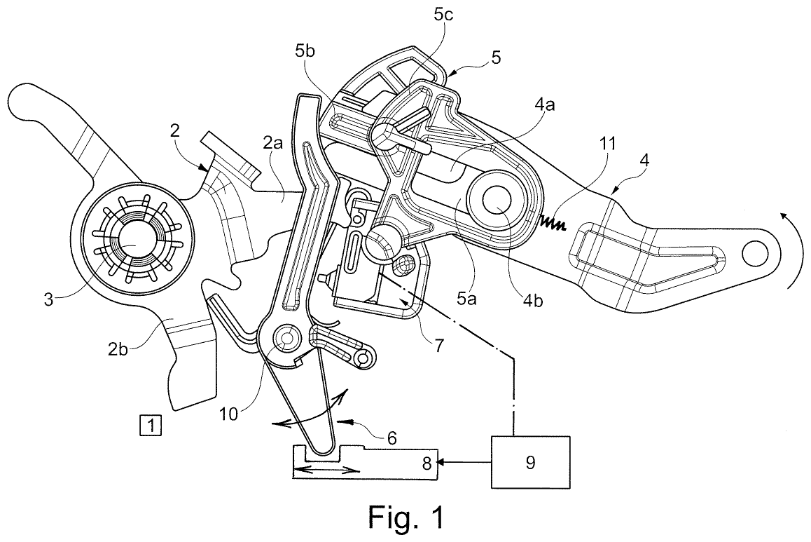

FIG. 1 to 4 show the motor vehicle lock according to the invention when the actuating lever is acted upon in the “securing device off” position,

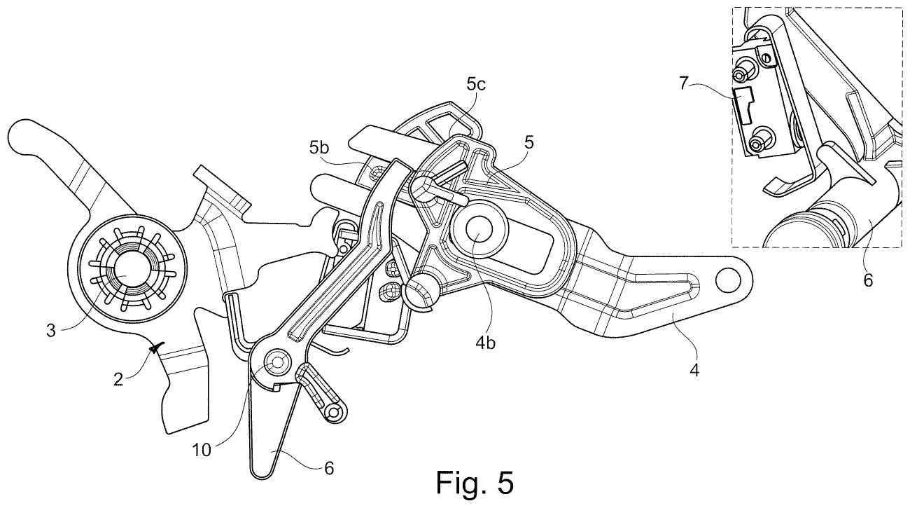

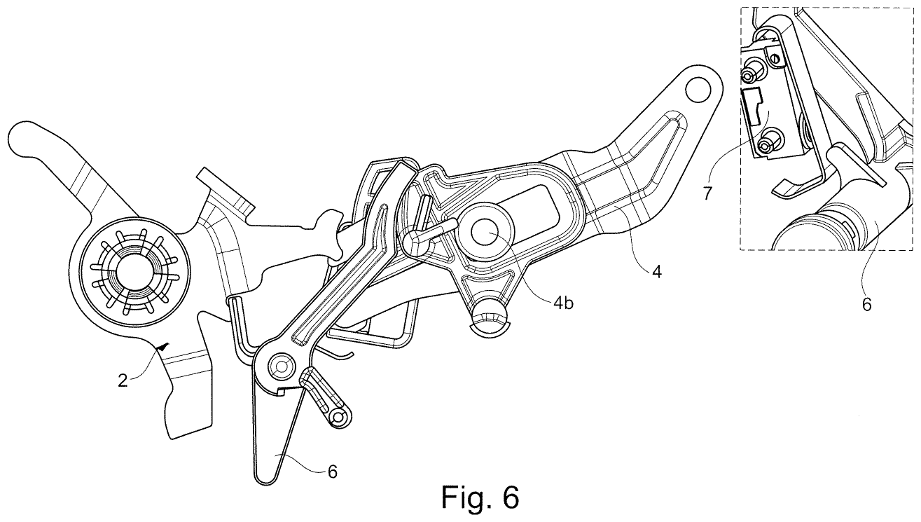

FIGS. 5 and 6 show the operation of the motor vehicle lock in the “securing device on” functional position, and

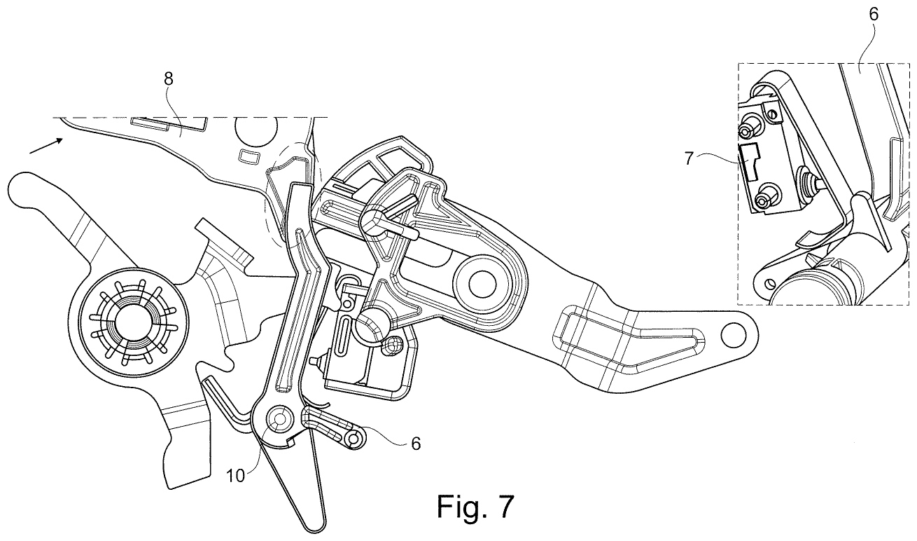

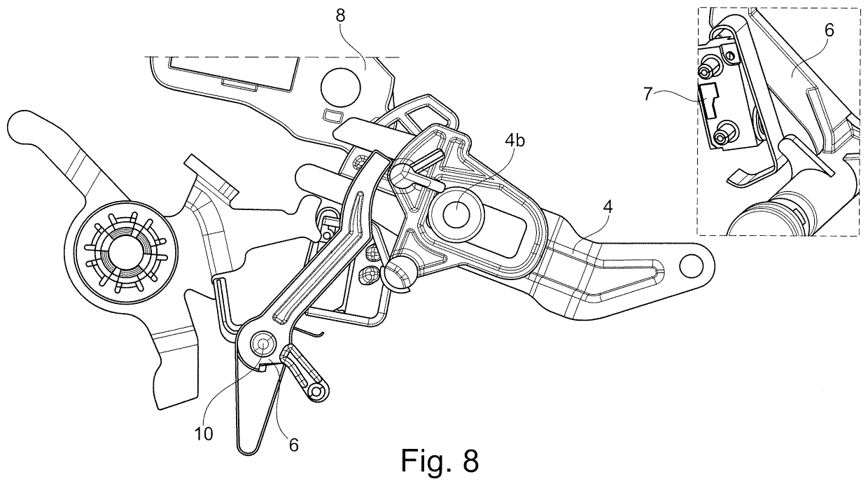

FIGS. 8 and 7 show the actuation of the securing device in the rest position.

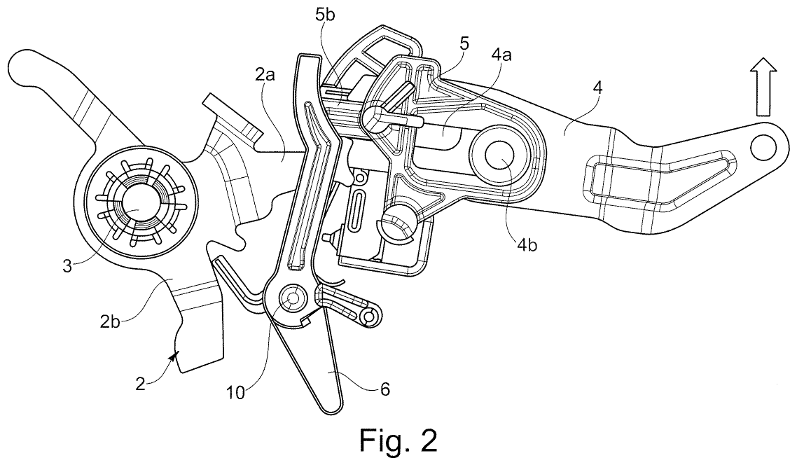

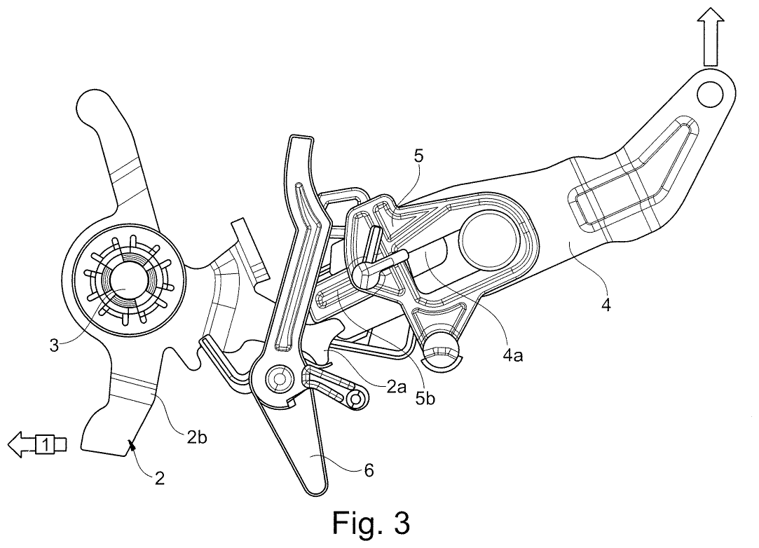

The drawings show a motor vehicle lock which is not limited to a motor vehicle door lock. Said lock has a locking mechanism 1, which is merely indicated in FIG. 1, consisting substantially of a catch and a pawl. In the functional position shown in FIG. 1, the locking mechanism 1 is in its closed state. In this case, the pawl is in latching engagement with the catch. In order to open the locking mechanism 1, a release lever 2 must be pivoted clockwise about its axis 3, as can be seen in the transition from FIG. 1 and FIG. 2 and further to FIG. 3. In the functional position shown in FIG. 3, the locking mechanism 1 is open, i.e. the pawl has been lifted from its latching engagement with the catch by means of the release lever 2. The catch then opens with the aid of a spring and releases a previously caught locking pin. The locking mechanism 1 and with it the entire motor vehicle lock and an associated motor vehicle door are opened.

The basic structure of the motor vehicle lock shown comprises an actuating lever chain 2, 4, which is equipped with at least the above-mentioned release lever 2 and an actuating lever 4. Also implemented is a securing device 5, 6, 7 which, in its “secured” position, mechanically decouples the actuating lever 4 from the release lever 2 and, in its “unsecured” position, mechanically couples the two levers 2, 4 to one another.

For this purpose, the securing device 5, 6, 7 has a coupling slide 5 which is supported on the actuating lever 4 and is predominantly linearly movable. The coupling slide 5 can be used for mechanically decoupling/coupling the actuating lever 4 from/to the release lever 2, as will be explained in more detail below. For this purpose, the coupling slide 5 can be acted upon with the aid of the securing device 5, 6, 7 and specifically a securing lever 6 as a component of the securing device 5, 6, 7. In addition to the coupling slide 5 and the securing lever 6, the securing device 5, 6, 7 also has a sensor 7 that monitors the position of the securing lever 6. According to the exemplary embodiment, the sensor 7 is a switch and in particular a microswitch 7.

Furthermore, a comparative view of FIGS. 1 and 7 in particular reveals that an electromotive drive 8 is also provided, with the aid of which the securing lever 6 can be pivoted about its axis 10. For this purpose, the electromotive drive 8 has a slide or adjusting slide which can pivot the securing lever 6 about its axis 10 in a counterclockwise and clockwise direction. For example, a pivoting movement of the securing lever 6 about its axis 10, starting from the functional position in FIG. 7 in the transition to FIG. 8, corresponds to the securing device 5, 6, 7 moving from its “off” functional position in FIG. 7 to the “on” functional position of the securing device 5, 6, 7 as shown in FIG. 8. In order to switch the securing device 5, 6, 7 off again from the functional position in FIG. 8, it is only necessary to switch off the electromotive drive 8 according to the exemplary embodiment. The securing lever 6 then returns to its “off” position (with the aid of a spring) as shown in FIG. 7.

Like the sensor or microswitch 7, the electromotive drive 8 is connected to a common control unit 9. As a result, the control unit 9 can control the electromotive drive 8 or not, depending on the position of the securing lever 6 and thus whether the sensor 7 is acted upon or not. It can be seen that the position of the securing lever 6, for example in the rest position according to FIG. 7, which is not acted upon with the aid of the electromotive drive 8, corresponds to the fact that the securing device 5, 6, 7 as a whole assumes its “off” functional position. In contrast, the “on” functional position of the securing device 5, 6, 7 according to FIG. 8 corresponds to the fact that the electromotive drive 8 pivots or has pivoted the securing lever 6 clockwise about the axis 10 until the securing lever 6 comes into contact with the coupling slide 5 and moves it into its “disengaged” position. At the same time, the sensor 7 is acted upon, as the two enlarged individual illustrations in FIGS. 7 and 8 clearly show.

The coupling slide 5 is supported on the actuating lever 4 so as to be predominantly linearly movable. In addition, a spring 11, which is merely indicated, ensures that the coupling slide 5 is acted upon in the direction of its “engaged” position shown in FIG. 1 to 4. As soon as the coupling slide 5 is acted upon against the force of the spring 11 with the aid of the securing lever 6, the coupling slide 5 moves to its “disengaged” position, as shown in FIGS. 5 and 6. This corresponds to the fact that the securing lever 6 and with it the entire securing device 5, 6, 7 assumes its “secured” or “on” functional position, as can be seen, for example, in the transition from FIG. 7 to FIG. 8.

It can be seen that the coupling slide 5 is guided in its entirety in a recess 4a in the actuating lever 4. In addition, the coupling slide 5 itself is equipped with a longitudinal bore 5a. In this context, the design is further such that the coupling slide 5 is held in place on the actuating lever 4 with the aid of a guide element 4b. For this purpose, the guide element 4b on the actuating lever 4 passes through the aforementioned longitudinal bore 5a on the coupling slide 5. In addition, the guide element 4b in question on the actuating lever 4 engages over the longitudinal bore 5a in question.

The control unit 9 is now configured in such a way that it releases or can release the electromotive drive 8 and thus also the securing lever 6 as required. In this case, when the actuating lever 4 is acted upon, it first ensures that the previously secured securing lever 6 is pivoted. This results in the coupling slide 5 “engaging” and, as the actuating lever 4 continues to move, the engaged coupling slide 5 ultimately acts on the release lever 2 in such a way that the release lever 2 performs a clockwise movement about its axis 3 and thus opens the locking mechanism 1. This includes an “override” action. This means that the securing device 5, 6, 7 is initially “unsecured” by a (single) stroke of the actuating lever 4 and at the same time the locking mechanism 1 is opened via the release lever 2.

The mode of operation is as follows. FIG. 1 to 4 first show an actuation of the motor vehicle lock with the aid of the actuating lever 4, namely in the “unsecured” position of the securing device 5, 6, 7. This includes the “engaged” functional position of the coupling slide 5. If, in this functional position, the actuating lever 4 is acted upon to open the locking mechanism, as can be seen in the transition from FIG. 1 to FIG. 2, this corresponds to a pivoting movement of the actuating lever 4 about its axis 4b, namely in a counterclockwise direction. In fact, the axis 4b in question of the actuating lever 4 is defined by the guide element 4b. This can be seen in the transition from FIG. 1 to FIG. 2, in which the actuating lever 4 has completed a pivoting movement about the axis 4b in question in the counterclockwise direction indicated there.

The counterclockwise pivoting movement of the actuating lever 4 about its axis 4b means that, during the transition from FIG. 1 to FIG. 2 and further to FIG. 3, the coupling slide 5 can move with a stop lug 5b against an extension arm 2a of the release lever 2 and in this way ensures that the release lever 2 performs a clockwise movement about its axis 3, as can be seen from the sequence of figures, in particular in FIGS. 2 and 3. The clockwise movement of the release lever 2 about its axis 3 causes a release arm 2b of the release lever 2 to act on the closed locking mechanism 1 in such a way that the pawl, which is in latching engagement with the catch, is lifted from its engagement. The catch opens with the aid of a spring so that a locking pin is released and the motor vehicle lock and an associated motor vehicle door are opened.

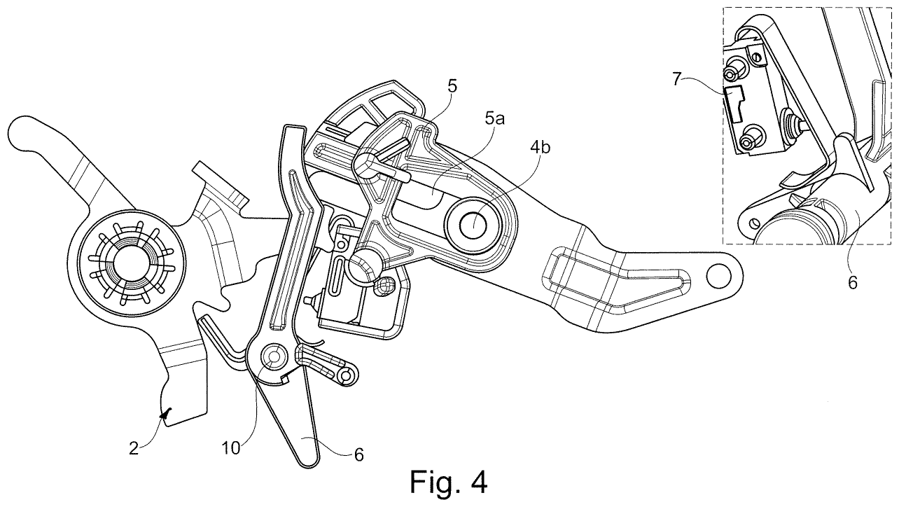

Starting from this open state of the locking mechanism 1 in the illustration according to FIG. 3, the fact that the actuating lever 4 is no longer acted upon about its axis 4b in a counterclockwise direction now results in the actuating lever 4 being returned to its rest position shown in FIG. 4. This may be ensured by a spring (not explicitly shown) that acts on the actuating lever 4 in the direction of the rest position shown in FIG. 4.

In the transition from FIG. 4 to FIG. 5, it can be seen that in the rest state shown in FIG. 4, the securing device 5, 6, 7 has been acted upon. This corresponds to the fact that the securing lever 6 has been pivoted clockwise about its axis 10 with the aid of the electromotive drive 8 primarily indicated in FIGS. 7 and 8. This can best be understood by looking at the sequence of FIGS. 4 and 5. The clockwise pivoting movement of the securing lever 6 about its axis 10 results in the securing lever 6 engaging over the stop lug 5b on the coupling slide 5 during this process and ultimately coming to rest against a contour 5c of the coupling slide 5.

If, starting from the rest position in FIG. 5, the actuating lever 4 is now acted upon again in a counterclockwise direction about its axis 4b, this corresponds to the fact that the stop lug 5b of the coupling slide 5 cannot (or can no longer) engage with the extension arm 2a on the release lever 2. This is because the securing lever 6, which is pivoted clockwise about its axis 10, has moved the coupling slide 5 against the force of the spring 11 and, in the exemplary embodiment, “to the right” during the transition from FIG. 4 to FIG. 5. As soon as the securing lever 6 has assumed its “on” functional position and consequently the securing device 5, 6, 7 has also assumed its “on” functional position as shown in FIG. 5 to 6, the sensor or microswitch 7 is simultaneously acted upon by the securing lever 6. This can best be understood from the enlarged detailed illustration in FIG. 5 to 7. In any case, an opening movement of the actuating lever 4 during the transition from FIG. 5 to FIG. 6 has the overall effect that the closed locking mechanism 1 is not acted upon. This means that the actuating lever chain 2, 4 performs an idle stroke relative to the locking mechanism 1. At the end of this movement and when the actuating lever 4 is no longer acted upon, the actuating lever 4 returns to its rest position, as shown in FIG. 7.

It can be seen from the functional position in FIG. 7 that in this case the securing device 5, 6, 7 has assumed its “off” position, whereas in FIG. 8 the securing device 5, 6, 7 is shown in its “on” functional position. As a result of this, the coupling slide 5 is transferred from its “engaged” position in FIG. 7 to the “disengaged” functional position in FIG. 8 and vice versa.

In other words, in FIG. 8 and in the “on” functional position of the securing device 5, 6, 7, the electromotive drive 8 ensures that the securing lever 6 assumes the position shown there and in doing so acts on the coupling slide 5 against the force of the spring 11 into its right end position shown in FIG. 8. As soon as the control unit 9 no longer acts on the electromotive drive 8 starting from this “on” functional position of the securing device 5, 6, 7, the electromotive drive 8 releases the securing lever 6 as required. Now the securing lever 6 can be pivoted counterclockwise about its axis 10 from the functional position in FIG. 8 with the aid of the spring 11 acting on the coupling slide 5 until the functional position of the securing lever 6 as shown in FIG. 7 is reached. This corresponds to the “off” position of the securing device 5, 6, 7 and the “engaged” state of the coupling slide 5. The transition from the functional position in FIG. 8 to FIG. 7 can also simply be brought about when the electromotive drive 8 is no longer acted upon by the actuating lever 4 being acted upon about its axis 4b in a counterclockwise direction.

### LIST OF REFERENCE NUMBERS

1 Locking mechanism
2 Release lever
2a Extension arm
2b Release arm
3 Axis
4 Actuating lever
4a Recess
4b Guide element/axis
2, 4 Actuating lever chain
5 Coupling slide
5a Longitudinal bore
5b Stop lug
5c Contour
6 Securing lever
7 Sensor, microswitch
5, 6, 7 Securing device
8 Electromotive drive
9 Control unit
10 Axis
11 Spring

1. A motor vehicle lock comprising:
an actuating lever chain with at least one release lever and at least one actuating lever, and
a securing device which, in a secured position, mechanically decouples the actuating lever from the release lever, and in an unsecured position, mechanically couples the actuating lever and the release lever to one another,
wherein the securing device has a coupling slide, which is supported on the actuating lever and is linearly movable for selectively mechanically decoupling or coupling the actuating lever from or to the release lever.

2. The motor vehicle lock according to claim 1, wherein the securing device further has a securing lever, and wherein the coupling slide is acted upon by the securing lever.

3. The motor vehicle lock according to claim 1, further comprising a spring, wherein the coupling slide is acted upon in a direction of an engaged position of the coupling slide by the spring.

4. The motor vehicle lock according to claim 2, wherein, in the secured” position of the securing device, the securing lever acts on the coupling slide against the force of the spring into a disengaged position of the coupling slide.

5. The motor vehicle lock according to claim 1, wherein the coupling slide is guided in a recess in the actuating lever.

6. The motor vehicle lock according to claim 1, wherein the coupling slide has a longitudinal bore through which a guide element on the actuating lever passes.

7. The motor vehicle lock according to claim 1, further comprising an electromotive drive, wherein the securing lever is pivotable about an axis by the electromotive drive.

8. The motor vehicle lock according to claim 1, further wherein the securing lever has a sensor that monitors a position of the securing lever.

9. The motor vehicle lock according to claim 8, further comprising an electromotive drive that drives the securing lever and a control unit, wherein the sensor and the electromotive drive are connected to the control unit that controls operation of the securing lever.

10. The motor vehicle lock according to claim 9, wherein the control unit releases the electromotive drive and thus the securing lever, so that when the securing lever is acted upon, the actuating lever pivots the secured securing lever, thereby engaging the coupling slide.

11. The motor vehicle lock according to claim 8, wherein the sensor is a microswitch.

12. The motor vehicle lock according to claim 1, wherein the actuating lever is operable in an override function in which a single stroke of the actuating lever is sufficient to both unlock and open the motor vehicle lock.
